(19) United States
(12) Patent Application Publication
(10) Pub. No.: US 2014/0214904 A1
(43) Pub. Date: Jul. 31, 2014

(54) DATA ENTRY

(71) Applicant: TRAVELTEXT AS, Sandnes (NO)

(72) Inventors: Lennart IMS, Hommersaak (NO); Eric CARR, Sandnes (NO); Jarl-Gunnar LIER, Oltedal (NO)

(73) Assignee: TRAVELTEXT AS, Sandnes (NO)

(21) Appl. No.: 13/757,443

(22) Filed: Feb. 1, 2013

(30) Foreign Application Priority Data
Jan. 28, 2013 (GB) 1301485.7

(51) Int. Cl. G06F 17/30

(52) U.S. Cl. CPC G06F 17/30289
USPC 707/805

(57) ABSTRACT

There is set forth herein in one embodiment a method of receiving data for a plurality of fields in a target database comprising allowing the user to enter a single composite data string, determining at least one piece of contextual data, and using the data string and said contextual data to generate a plurality of data elements suitable for entry into said target database fields.

### CROSS REFERENCE TO RELATED APPLICATIONS

This application claims priority under 35 USC §119 from United Kingdom Patent Application No. 1301485.7 filed on Jan. 28, 2013 in the Intellectual Property Office of the United Kingdom, the entire disclosure of which is incorporated herein by reference.

### BACKGROUND

This invention relates to methods, systems and software for allowing users to enter information into a database more conveniently and rapidly. It relates particularly, although not exclusively, to arrangements which permit the entry of data into a target enterprise system such as a travel and expenses management system (EMS) or a customer relationship management (CRM) system.

One of the largest challenges with software systems like CRM and EMS, is poor usability: Interaction with such systems is generally through a complex set of individual graphical user interface elements which are provided together on a number of screens. This provides the user with a multi-operational interface but one that is relatively time-consuming. The nature of the interface more or less forces the user to make a number of interactions in order to complete even the simplest operations. Such interactions might include navigation to the appropriate web-site page, visual orientation to find the right place on the page at which to enter data and to determine the data required, dealing with a menu, drop-down box or other input mechanism and typing the required information. This process, or at least the majority of it, typically needs to be repeated for each individual piece of data being input which makes the process relatively time-consuming.

The difficulty outlined above is exacerbated when entering such data using a mobile device such as a smartphone as there is limited space available on the screen at any one time meaning that many different screens are required.

On the other hand the importance of usability in such software systems is increasing over time. Customers are tending to become less patient to work through malfunctions or gaps in user ‘safety’ (procedures put in place to avoid user errors); there is increasingly an expectation that the usability of systems should be somewhat intuitive.

### BRIEF DESCRIPTION

There is set forth herein in one embodiment a method of receiving data for a plurality of fields in a target database comprising allowing the user to enter a single composite data string determining at least one piece of contextual data, and using the data string and said contextual data to generate a plurality of data elements suitable for entry into said target database fields.

### DRAWINGS

FIGS. 1a and 1b are two halves of a flow chart representing operation of a system in accordance with an embodiment of the invention;

FIGS. 2a to 2c illustrate respective exemplary user interfaces.

### DETAILED DESCRIPTION

It is an aim of the present invention to address the issues mentioned above and when viewed from a first aspect the invention provides a method of receiving data for a plurality of fields in a target database comprising:

allowing the user to enter a single composite data string;

determining at least one piece of contextual data; and

using said data string and said contextual data to generate a plurality of data elements suitable for entry into said target database fields.

The invention also extends to a system for receiving data for a plurality of fields in a target database said system being arranged to:

allow the user to enter a single composite data string;

determine at least one piece of contextual data;

use said data string and said contextual data to generate a plurality of data elements suitable for entry into said target database fields; and

output said data elements to the user to allow the user to verify them.

The invention further extends to a computer software product, whether or not on a carrier, for receiving data for a plurality of fields in a target database comprising instructions for:

allowing the user to enter a single composite data string;

determining at least one piece of contextual data; and

using said data string and said contextual data to generate a plurality of data elements suitable for entry into said target database fields.

Thus it will be seen by those skilled in the art that in accordance with the invention, rather than a user having to enter individual pieces of data separately into a target database, he or she can include them in a single composite data string. By using this data string in conjunction with the contextual data, the required data elements can be produced which can then be put into fields in a database.

The user could enter the composite data string in any of a number of different ways. For example the data entry could be mediated by a text box or similar graphical user interface element as part of a Web page or a dedicated software application—e.g. designed to be run on a mobile device such as a smartphone. In another set of embodiments the composite data string may be contained in a message sent by a user to the system. Conveniently such a message is of a pre-existing type thereby simplifying implementation, making the system easier to use for a user who is able to utilise familiar applications to submit the message and potentially obviating the need for the user to download any special software. A non-exhaustive list of suitable message types may include, email, Short Message 5 Service (SMS) text messages, social-networking site messages, micro-blog postings etc.

It is not essential for the user directly to generate text: the system could, for example be arranged to interpret spoken phrases.

As mentioned above the contextual data is used in the generation of the data elements for entry into the target database fields. The contextual data could simply form one of the data elements and/or it could be used to aid parsing of the composite data string to produce the data elements. Examples of possible contextual data include the user's identity, time, date, location, identification of the device used to enter the information (either by owner or type), previous data entered etc. To give an example of how such contextual data might be used—the contextual data might comprise the date and this is simply entered into a date field in the database.

Although it is envisaged that the invention may be used where the target database is included in systems which allow anonymous entries to be made, it is recognised that in most cases where the target database is part of an enterprise management system such as EMS or CRM, entries will always be associated with authorised users. Thus in a set of embodiments the contextual data comprises the identity of the user. In a set of embodiments the contextual data comprises data in addition to the user's identity such as one of the other contextual data types listed hereinabove.

In a set of embodiments the user's identity is used to determine what the target database is and therefore what data is required for entry into the fields of that database. This would allow a generic data entry portal to be used with a plurality of different target databases. Of course typically the user's identity will itself form one of the data elements for entry into a corresponding field in the target database—where this is required for user authentication.

Where the contextual data comprises location, this might be used to match part of the composite data string to an entry on a predefined list associated with that location. This may be relatively crude: e.g. using the location data to determine which country the user is in and then seeking to match a city name to one of a list of cities in that country. This would allow a user say to enter the name “Birmingham” without having to specify whether it is Birmingham, UK or Birmingham, Ala. that is meant. Equally it could be more refined: e.g. when the user enters “hotel”, “station” or “airport” the user's GPS coordinates are used to determine (if possible) exactly which one is meant.

In a set of embodiments natural language processing is used to interpret the composite data string. This means that it is not essential for the composite data string to have a precisely predetermined format. The Applicant has appreciated that the combination of natural language processing and the use of contextual data to interpret the inputs from a user is particularly powerful and makes embodiments of the invention suitable for use by non-advanced users—that is users who do not know the syntax and parameters which are expected by the target database.

As is outlined above contextual data, e.g. time, date device type or location may be obtained from the source—i.e. the device from which the user is inputting the data. However additionally or alternatively it is envisaged that contextual data could be obtained locally from a server in communication with the user's device and/or from a system including the target database. Thus for example the contextual data could comprise subscription or account data either from the server or from the target system. In another set of examples it could comprise a prediction engine based on statistical or other learning algorithms. In another set of examples the contextual data could comprise information specific to the target system such as the types of form available (e.g. when the target system, requires a form to be filled out).

Any combination of different contextual data types may be used.

Although not essential, in a set of embodiments one or more of the data elements generated are output to the user to allow the user to verify them. This can prevent inaccurate data entering the database where the algorithm used to recognise the data elements is not perfect, and also allows the opportunity to review what is going to go into the database to ensure that he/she has given the correct information. The data elements may all be output or only those which are above a confidence threshold. The output could be audible, e.g. spoken by a text-to-speech engine, or visual or a combination of both. If the entry falls below a threshold confidence level an error message may be generated.

In a set of embodiments the system includes the target database and is arranged to enter the data elements into the required database fields. In such embodiments the data elements may be entered after they have been verified by the user if such a feature is provided, or they may be entered first and then removed or amended if the user does not verify one or more data elements.

In other embodiments the data elements are stored and/or transmitted to another system for subsequent automatic entry into the target database fields.

Embodiments of the invention may be used in a variety of different applications—wherever it is necessary for a user to enter multiple pieces of data into a database where this has some dependence on the context of the data entry. One exemplary set of embodiments comprises an expenses entry system such as a travel and expenses reporting system. Another exemplary set of embodiments comprises a client relationship monitoring system.

As well as entering data into a target database the data string may be used to trigger an action or event in a system including the target database. This could. for example, be creating a new record, submitting a claim etc.

However the Applicant has appreciated that the principles discussed herein can also be used to control the actions of a target system even where no data is entered into a database. Thus when viewed from another aspect the invention provides a method of receiving a control command for a target system:

allowing the user to enter a single composite command string;

determining at least one piece of contextual data; and

using said text string and said contextual data to generate one or more control commands for said target system.

This aspect of the invention also extends to a system for controlling the actions of a target system said system being arranged to:

allow the user to enter a single composite command string;

determine at least one piece of contextual data;

use said data string and said contextual data to generate a one or more control commands for said target system; and

output said control commands to the user to allow the user to verify them.

The invention further extends to a computer software product, whether or not on a carrier, for controlling a target system comprising instructions for:

allowing the user to enter a single composite command string;

determining at least one piece of contextual data; and

using said command string and said contextual data to generate one or more control commands for said target system.

Thus it will be seen by those skilled in the art that in accordance with this aspect of the invention, rather than a user having to enter individual control commands and parameters, he or she can include them in a single composite command string. By using this command string in conjunction with the contextual data, the required control commands can be better interpreted and effected in the target system.

The user could enter the composite command string in any of a number of different ways. For example the command entry could be mediated by a text box or similar graphical user interface element as part of a Web page or a dedicated software application—e.g. designed to be run on a mobile device such as a smartphone. In another set of embodiments the composite command string may be contained in a message sent by a user to the system. Conveniently such a message is of a preexisting type thereby simplifying implementation, making the system easier to use for a user who is able to utilise familiar applications to submit the message and potentially obviating the need for the user to download any special software. A non-exhaustive list of suitable message type may include, email, Short Message Service (SMS) text messages, social-networking site messages, micro-blog postings etc.

It is not essential for the user directly to generate text: the system could, for example be arranged to interpret spoken phrases.

As mentioned above the contextual data is used in the generation of the control commands. The contextual data could be used to aid parsing of the composite command string to produce the control command. Examples of possible contextual data include the user's identity, time, date, location, identification of the device used to enter the information (either by owner or type), previous control commands given etc. To give an example of how such contextual data might be used—the contextual data might comprise the date and this is used to interpret a command including the word “tomorrow”.

In a set of embodiments the contextual data comprises the identity of the user. In a set of embodiments the contextual data comprises data in addition to the user's identity such as one of the other contextual data types listed hereinabove.

In a set of embodiments the user's identity is used to determine what the target system is and therefore what control commands are available. This would allow a generic control portal to be used with a plurality of different target systems. Of course typically the user's identity will itself form one of the data elements for entry into a corresponding field in the target database -where this is required for user authentication.

Where the contextual data comprises location, this might be used to match part of the composite command string to a control command on a predefined list associated with that location. This may be relatively crude: e.g. using the location data to determine which building a user is in for a building control system. Equally it could be more refined: e.g. when the user is near a window and enters “close curtains” the user's exact location used to determine (if possible) exactly which curtains are meant.

In a set of embodiments natural language processing is used to interpret the composite command string. This means that it is not essential for the composite command string to have a precisely predetermined format. The Applicant has appreciated that the combination of natural language processing and the use of contextual data to interpret the inputs from a user is particularly powerful and makes embodiments of the invention suitable for use by non-advanced users—that is users who do not know the syntax and parameters which are expected by the target system.

As is outlined above contextual data, e.g. time, date device type or location may be obtained from the source—i.e. the device from which the user is inputting the command. However additionally or alternatively it is envisaged that contextual data could be obtained locally from a server in communication with the user's device and/or from a target system. Thus for example the contextual data could comprise subscription or account data either from the server or from the target system. In another set of examples it could comprise a prediction engine based on statistical or other learning algorithms. In another set of examples the contextual data could comprise information specific to the target system such as the types of control command available.

Any combination of different contextual data types may be used.

Although not essential, in a set of embodiments one or more of the control commands generated are output to the user to allow the user to verify them. This can prevent unintended effects where the algorithm used to recognise the control commands is not perfect, and also allows the opportunity to review what is going to happen to ensure that he/she has given the correct command. The control commands may all be output or only those which are above a confidence threshold. The output could be audible, e.g. spoken by a text-to-speech engine, or visual or a combination of both. If the control command falls below a threshold confidence level an error message may be generated.

In a set of embodiments the system includes the target system and is itself controlled by the control commands. In such embodiments the control commands may be effected after they have been verified by the user if such a feature is provided.

In other embodiments the control commands are stored and/or transmitted to another system for subsequent control of the target system.

Embodiments of the invention may be used in a variety of different applications—wherever it is necessary for a user to control a target system where this has some dependence on the context of the control command issued. One exemplary set of embodiments comprises a home 5 automation system.

An embodiment of the invention will now be described, by way of example only, with reference to the accompanying drawings in which:

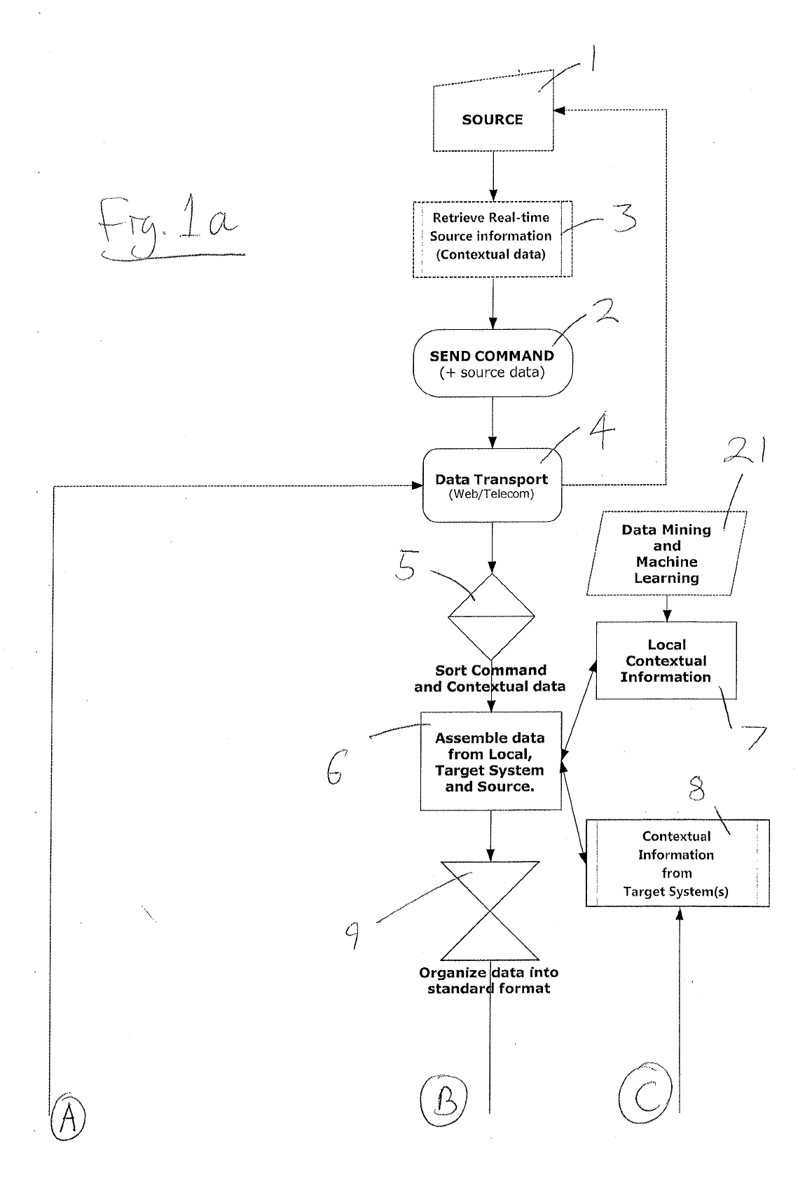

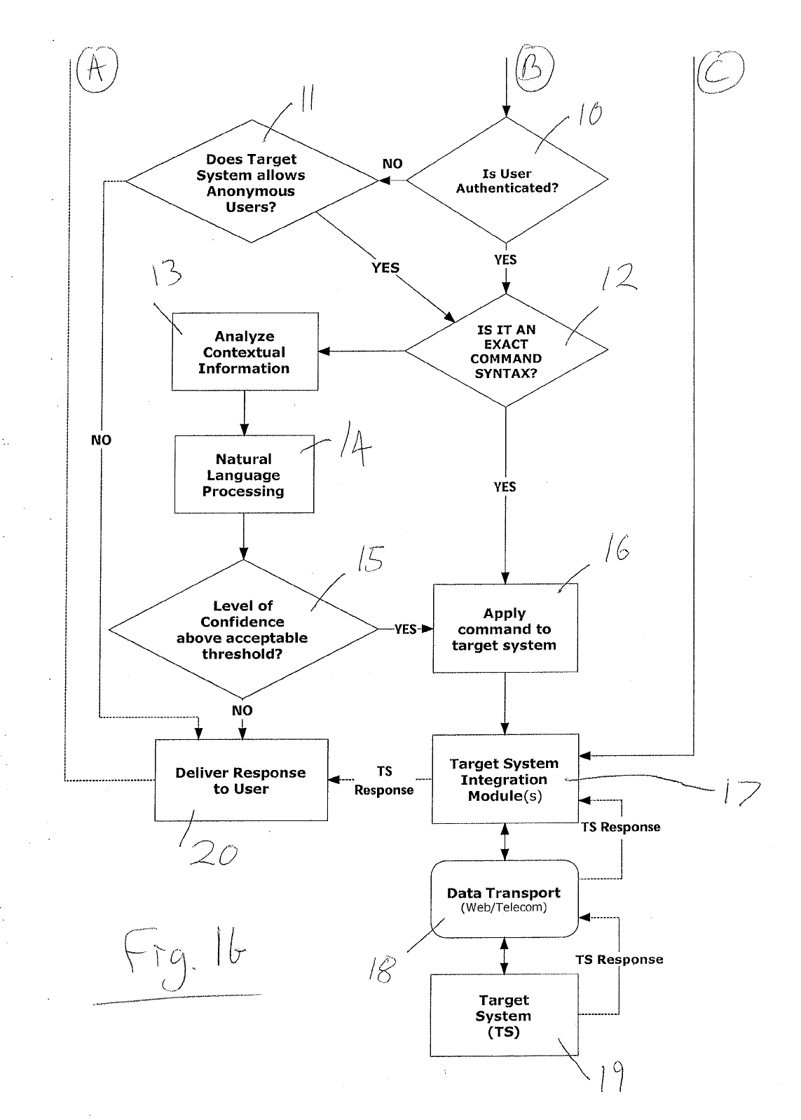

FIGS. 1a and 1b are two halves of a flow chart representing operation of a system in accordance with an embodiment of the invention; and

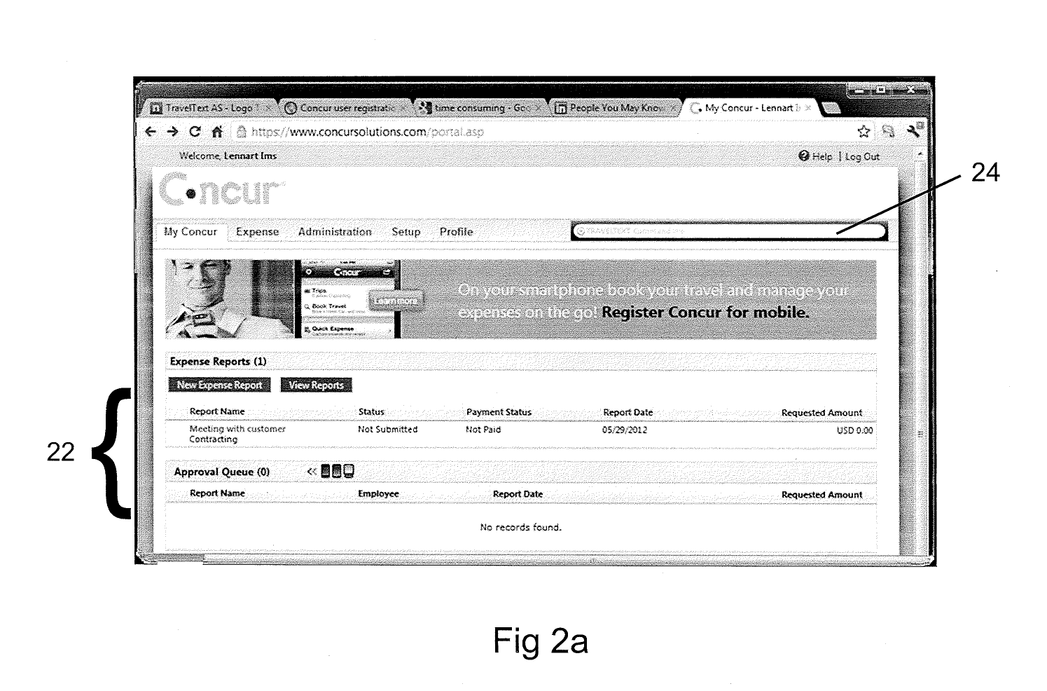

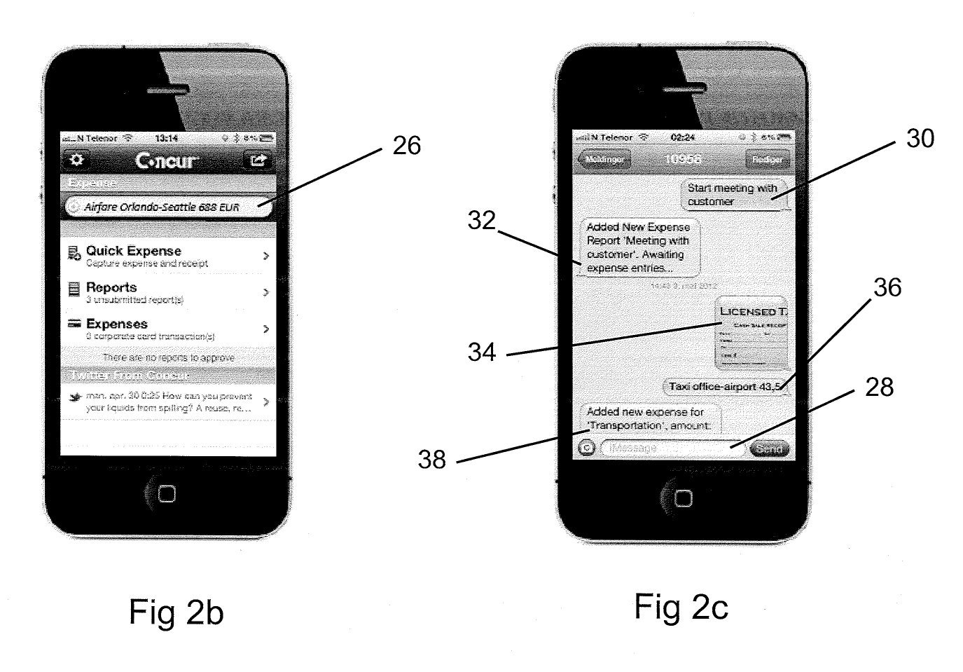

FIGS. 2a to 2c illustrate respective exemplary user interfaces.

Referring to FIGS. 1a and 1b there may be seen a flow chart illustrating exemplary operation of a system in accordance with the invention. The letters A, B and C indicate connecting lines across the two Figures.

At step 1 the source data is generated by a user who provides data input—e.g. via a mobile device. The source device converts the user's input to a text string. This could simply be through recognition of keystrokes on a keyboard or taps on a touch-screen, or it could be for example through a voice recognition engine. The text string includes the information the user wishes to input into the database in a very simple way with no particular format and constitutes a command to a target system incorporating a target database. Since the text may be entered in a single field on the interface this may be referred to as a single field command interface (SFCI)

At step 2 the command is sent to a processing module 5 provided on a dedicated SCR server by means of a data transport network 4 which could be fixed and/or wireless, public and/or private. The processing module structures all of the data that comes from the source 1.

At step L3 real-time data relating to the data input is gathered, such as the time, date location and device type. This data is sent to the processing module 5 along with the command derived from the user's input, although the date and time could be determined locally by the processor or further downstream in the system.

Step 6 illustrates the assembly of contextual data. This may come from the source device 1, as previously explained, or from data generated and stored 5 locally 7 at the SFCI server. This local contextual data could include subscription data either from the SFCI server or a local copy of the subscription data from the target system. The local contextual data could also comprise data derived from a data mining or machine learning module 21. This could, for example, examine habits of particular users, trends of users in general, common errors and other issues and use these to provide predictions or weight possible alternatives.

Contextual data may also come from the target system as shown in step 8. All of the contextual data that may be useful for interpreting the command is gathered at this point 6. This is followed at point 9 by organising the data into a standard format—i.e. all of the data from the preceding steps is packaged up.

At step 10 a check is carried out as to whether user authentication data in the correct format is available. If such authentication data is available the system proceeds to step 12. If no data is available a check is made as to whether the target system nonetheless accepts entries which are not validly associated with a registered user—i.e. anonymous entries. If such entries are allowed then the system can proceed to step 12, but if not a response in the form of an error message is issued at step 20 which is delivered via the communication network 4 to the user's device 1.

At step 12 the command is checked to determine whether it is an exact match to a pre-defined template. Based on user and target system information a set of applicable command templates is pre-defined for each target system. If the command exactly matches such a pre-defined template there is no need to perform any further processing and it can be passed straight to the target system at step 16. Otherwise at step 13 the system proceeds to analyse the command using the contextual data.

Step 13 involves using the contextual data to interpret the command and so ultimately to attempt to find the best match to one of the pre-defined templates. An example of how this is done is given further below. This process works in conjunction with natural language processing 14 which also helps to interpret the command by analysing it for alternative syntaxes, typographic errors, synonyms and abbreviations, and word stemming and lemmatisation.

The result of the contextual data analysis 13 and the natural language processing 14 is a ‘best-fit’ interpretation of the command against one of the pre-defined templates. However the interpretation algorithms are also configured to generate a score indicating the strength of the match. These combine to give an overall confidence level indicator—that is an indicator of the likelihood that the selected ‘best fit’ template is indeed the correct one. This could just be based on the aggregate absolute value of the score from each algorithm or could include a consideration of the relative score of the selected template against the other alternatives.

The confidence level indicator is tested against a threshold at step 15 to determine whether the command interpretation is accurate enough to be used. The threshold may be determined by the target system. If the confidence meets the threshold then the interpreted command is applied to the target system at step L16. If the confidence level is not high enough to meet the threshold, an error message response is sent back (step 20) to the user's device 1.

Step 16 represents a common interface for steps 12 and 15, and forwards the command to the target system integration module 17. When several target systems are connected to the same SFCI server, this module also address the appropriate target system integration module based on a target system identification that has already taken place in one or more of the preceding steps.

Each target system requires its own integration module 17 as application programming interfaces and data structures vary between target systems. Each module 17 is responsible for all communication with one specific target system 19. This module 17: handles requests for contextual information initiated by step 8; attempts to apply commands to a target system initiated by step 16; and interprets responses from the target system, creates human readable information and forwards it to the feedback module at step 20.

The target system integration module 17 communicates over a suitable data network 18 with the target system 19. This may be any suitable 5 third party system which includes the target database such as a expenses management or client relationship management system. The target system 19 extracts the data from the command (which by this stage is in the form of a template pre-defined for the target system) and inserts the data into the appropriate fields in the appropriate records in its database. It then generates a response indicating success or failure and, in the former case, reproduces the data entered into its database to allow for the user to verify that processing has been carried out correctly. Status information or other information may also be sent.

Step 20 represents a common interface for delivering a response to the user's source device 1 via the data network 4. This could be the response just outlined or one of the error messages mentioned earlier.

Step 21 represents batch jobs running outside the main command process flow described above. Each job gathers historical usage data from the command process flow at regular intervals for analysis, and attempts to identify system- and user-specific trends, habits and common errors and issues. The goal of this analysis is to provide contextual data that may be helpful in future command processing. Analysis results are stored and used for future reference as output to step 7. Data sources include data logs from all SFCI server modules and records from applicable target systems.

FIGS. 2a to 2c show various example user interfaces. Thus in FIG. 2a is a web browser interface for an expenses management system. This comprises a reporting area 22 and a single text box 24 which acts as the single field command interface.

FIG. 2b shows a corresponding software application (‘app’) for a smartphone. This too has a single text box 26 for entry of the text string. In this Fig. can be seen an example of such a command “Airfare Orlando-Seattle 688 EU′”.

FIG. 2c shows a short message service (SMS) application. The standard SMS text entry box 28 may be used to enter the command. The display here shows examples of two commands entered and the responses from the system. The first command 30 is ‘Start meeting with customer” and the response 32 is “Added New Expense Report ‘Meeting with customer’. Awaiting expense entries”. This indicates that the system has correctly identified the information that the user wished to convey and has acted accordingly. The next submission from the user is forwarding of an electronic taxi receipt 34, followed by another command 36 which says “Taxi office-airport 43,5”. The system responds with a confirmation 38 “Added new expense for ‘Transportation’, amount:” (the remainder of the message is not shown in FIG. 2c). The user can thus be confident that the correct information has been entered into the target system. Also it shows by example the use of realtime contextual data gathered from the target system, which matched “Taxi” with the user's existing expense type setup and thus submitted the data into the corresponding expense category, in this case “Transportation”.

Two worked examples of the operation of the system described with reference to FIG. 1 will now be described.

In the first example a user named Mr Downing works for company A who use a third party expense management system (ACME Expense Management System) to handle expense reporting. Mr. Downing has already created a new expense report in the expense system and is now out on the road, having a lunch. He wants to add a new expense line item for his lunch to the expense report. He has a mobile phone and wishes to use the system's SMS interface. The details he needs to report are:
Meal type: Lunch
Vendor: Joe's Café
Cost: 20 dollars
Date: 22nd October
Time: 11.34 am

With reference to FIG. 1, at step 1 Mr. Downing types the following command into his mobile phone's SMS application: ‘Lunch $20 Joe's Cafe’. This command is sent to an SFCI server 2, 3 through a gateway 4 (telecom service vendor) and the connected carrier.

Contextual information is retrieved from Mr. Downing's mobile phone and the SMS application as follows: local date (22nd of October); local time (11:34) application/interface (SMS); and Mr. Downing's mobile phone number (+1 555 666 7777)

At step 5 the command data package is created by populating fields for time, date and Mr. Downing's mobile phone number. At this stage the system has not identified Mr. Downing as the user. First, the local contextual information storage module 7 is interrogated for information. It is determined that the user is downing@example.com and that Mr. Downing's mobile number was matched to the user record, which indicates that he has an active subscription with the ACME Expense Management system. It is therefore also determined that ‘ACME Expense Management’ is the target system.

Next, the “Contextual information from Target System” module 8 is interrogated. This module retrieves Mr. Downing's available expense types from ACME Expense Management to make sure the list is up to date. All retrieved data is assembled and passed on to step 9.

The result from steps 6, 7 and 8 is packaged into a standard SCR format and passed on to step 10. The package from step 9 contains valid authentication information, so the package is passed on to step 12.

A step 12 the command provided by the user is compared to each of the available command templates for the ACME Expense Management system. One template is defined as follows:
[expense type] [currency] [amount] [vendor]

Due to the following items, the command is determined as an exact match: -
the expense type is matched to an entry in the previously retrieved expense type list 8;
it is followed by a dollar sign, which is a valid currency;
that is then followed by a number, which is a valid amount; and
that is followed by any amount of text, interpreted as the vendor name.

The exact match enables the system to bypass 5 further command interpretation processing and therefore send the command directly to step 16.

The finalized command package is received at step 16. Based on the preceding target system identifier 7, this step 16 decides to pass the package on to the “ACME Expense Management” integration module 17. The ACME Expense Management module exposes an extensible markup language (XML) web service application programming interface (API).

This module 18 communicates Mr. Downing's intention to this API in the correct format, along with authentication information and other required details.

A response is received indicating that an expense line item was added to Mr. Downing's expense report. Based on this, a human-friendly response is generated: “Your expense entry for a $20 lunch at Joe's Cafe was added to your expense report.” This reply is sent to step 20, together with the original contextual data. The text from step 17 is received. Based on the contextual data, the system knows that Mr. Downing submitted the original command via SMS from mobile number +1 555 666 7777. An SMS is generated containing the reply text, and sent to Mr. Downing through step 4.

Thus it may be seen from this example that by sending a simple text message, Mr Downing has accurately been able to create a new entry in his EMS.

In the second example Ms. Gadget works for Company B. Company B uses the ACME Customer Relationship Management (CRM) system. Ms. Gadget is a sales representative that needs to update her CRM account on a regular basis in respect of previous and future events. She recently registered Steelway Enterprises as a new lead, and now she has just landed a new sales meeting with some of the decision makers in the company. She needs to create a new appointment in her CRM calendar.

Ms Gadget is using a desktop computer and the application is on Company B's intranet site, viewed in a web browser where the SFCI is connected to a textbox. The target system is the ACME Customer Relationship Management system and the required appointment details are:
Task: Create appointment
Type: Meeting
Meet with: Steelway Enterprises
Date: Tomorrow
Time: 10:00 am

Ms. Gadget types the following command into the textbox in her web browser: “Meeting tomorrow 10:00 with Steelway' and this is sent through steps 2, 3 and 4. When the command is submitted it is sent to an SFCI server through the internet. Contextual information retrieved from Ms. Gadget's computer is:
Ms. Gadget's authentication details: gadget@company.com (she is already authenticated as she has to be logged in to use the Company B's intranet);
local date (22nd of October);
local time (11:34); and
target system identity—this is already known based on the site's location on the intranet, in this case Ms. Gadget is already operating in Company B's intranet, which is a customized layer that communicates directly with the company's CRM system.

At step 5 the command data package is created and fields for time, date, target system and Ms. Gadget's identification are populated.

Next the local contextual information storage module 7 is interrogated for information. It is determined that Ms Gadget does have an active subscription; and that based on usage history, she often uses the word “meeting” when she means to create a calendar entry. After that, the “Contextual information from target systems” module 8 is interrogated. This module retrieves a list of Ms Gadget's leads and clients. All retrieved data is assembled and passed on to step 9 where the result from steps 6, 7 and 8 is packaged into a standard SCR format and passed on to step 10.

Step 10 seeks to determine whether the user has been authenticated. The package from step 9 contains valid authentication information, so the package is passed on to step 12.

At step 12 the system seeks to establish whether the command is an exact match to a predetermined template. The command is thus compared to each of the available command templates for the target system 19, in this case ACME Customer Relationship Management.

None of the templates matches exactly the syntax of the command provided by Ms. Gadget. The command is thus passed on to step 13 for further analysis.

At steps 13 and 14 the system analyses the contextual information and performs natural language processing in order to try to establish which of the predetermined templates is the best fit. So based on usage history, it is established that Ms Gadget often uses the word “meeting” when she means to create a calendar entry. The system uses this information, combined with knowing that creating calendar entries is a common activity in the target system, to assume that the command intention is to create a new calendar entry.

Now that the intention is known to involve a meeting, the system looks for relevant information like a date, time, entry type and other involved parties. The word “with” implies that the following text describes an involved party. The software can't find “Steelway” in Ms Gadget's lead or customer list, but there is a close match: “Steelway Enterprises”. This is assumed to be the other party with a high level of confidence, as there are no other close matches.

The modules also look for timing information. “Tomorrow” implies the date after today, so it can be assumed that since today is October 22nd (another piece of contextual information), the calendar entry date should be October 23rd. The text “10:00” matches a known time description format. Based on the format, and its proximity to “tomorrow” which increases the confidence factor, the calendar entry time is set to 10:00 with high confidence.

At step 15 the average confidence of accurate interpretations of all command parameters is calculated, and turns out to be above the required confidence for the combination of user/target system/command type. The finalized command package is therefore passed on to step 16. Had the confidence level been too low, a response would have been returned to Ms. Gadget through step 20 indicating this.

The finalized command package is received at step 16. Based on having identified the target system 19, this step decides to pass the package on to the “ACME Customer Relationship Management” integration module 17.

The ACME Customer Relationship Management system 19 exposes a representational state transfer (REST) API over the Internet. Module 17 communicates Ms. Gadget's intention to this API in the correct format, along with authentication information and other required details.

A response is received from the target system 19 indicating that a new calendar appointment has been created. Based on this, a human-friendly response is generated: “A calendar appointment with Steel way Enterprises has been created for October 23rd at 10:00 am.”

This reply is sent to step 20, together with the original contextual data. The text from step 17 is received and based on the contextual data, the system knows that Ms. Gadget submitted the original command via a textbox in a web browser in the company's intranet system. The reply text is therefore sent to the intranet system, which is awaiting a reply, and will show the result to Ms. Gadget on her screen, when received.

It will be appreciated by those skilled in the art that the examples given above involve entry of data into a database as well as initiation of system events. However aspects of the invention may equally be used to control a target system, to initiate system events without entering data into a database—e.g. in a building control or home automation system. In both cases the embodiments described enable non-advanced users, who are not familiar with particular command or data entry syntaxes or formats, successfully to interact with the target system.

1. A method of receiving data for a plurality of fields in a target database comprising:
allowing the user to enter a single composite data string;
determining at least one piece of contextual data; and
using said data string and said contextual data to generate a plurality of data elements suitable for entry into said target database fields.

2. A method as claimed in claim 1 comprising the user sending a message containing the composite data string to a server.

3. A method as claimed in claim 1 comprising using the contextual data to aid parsing of the composite data string to produce the data elements.

4. A method as claimed in claim 1 wherein the contextual data comprises the identity of the user.

5. A method as claimed in claim 4 wherein the contextual data comprises data in addition to the user's identity.

6. A method as claimed in claim 4 comprising using the user's identity to determine what the target database is.

7. A method as claimed in claim 1 wherein the contextual data comprises location, the method comprising using said location to match part of the composite data string to an entry on a predefined list associated with that location.

8. A method as claimed in claim 1 comprising using natural language processing to interpret the composite data string.

9. A method as claimed in claim 1 suitable for use by nonadvanced users.

10. A method as claimed in claim 1 comprising obtaining contextual data locally from a server in communication with the user's device and/or from a system including the target database.

11. A method as claimed in claim 1 comprising outputting one or more of the data elements to the user to allow the user to verify them.

12. A method as claimed in claim 1 comprising said composite data string triggering an action or event in a system including the target database.

13. A system for receiving data for a plurality of fields in a target database said system being arranged to:
allow the user to enter a single composite data string;
determine at least one piece of contextual data;
use said data string and said contextual data to generate a plurality of data elements suitable for entry into said target database fields; and
output said data elements to the user to allow the user to verify them.

14. A system as claimed in claim 13 comprising a server adapted to receive a message containing the composite data string from the user.

15. A system as claimed in claim 13 arranged to use the contextual data to aid parsing of the composite data string to produce the data elements.

16. A system as claimed in any of claim 13 wherein the contextual data comprises the identity of the user.

17. A system as claimed in claim 16 wherein the contextual data comprises data in addition to the user's identity.

18. A system as claimed in claim 16 comprising using the user's identity to determine what the target database is.

19. A system as claimed in claim 13 wherein the contextual data comprises location, the system being arranged to use said location to match part of the composite data string to an entry on a predefined list associated with that location.

20. A system as claimed in claim 13 arranged to use natural language processing to interpret the composite data string.

21. A system as claimed in claim 13 suitable for use by nonadvanced users.

22. A system as claimed in claim 13 arranged to obtaining contextual data locally from a server in communication with the user's device and/or from a system including the target database.

23. A system as claimed in claim 13 arranged to output one or more of the data elements to the user to allow the user to verify them.

24. A system as claimed in claim 13 arranged such that said composite data string triggers an action or event in a system including the target database.

25. A system as claimed in claim 13 wherein the system includes the target database and is arranged to enter the data elements into the required database fields.

26. A computer software product for receiving data for a plurality of fields in a target database comprising instructions for:
allowing the user to enter a single composite data string;
determining at least one piece of contextual data; and
using said data string and said contextual data to generate a plurality of data elements suitable for entry into said target database fields.

27. (canceled)

28. A method of receiving a control command for a target system:
allowing the user to enter a single composite command string;
determining at least one piece of contextual data; and
using said text string and said contextual data to generate one or more control commands for said target system.

29. A system for controlling the actions of a target system said system being arranged to:
allow the user to enter a single composite command string;
determine at least one piece of contextual data;
use said data string and said contextual data to generate a one or more control commands for said target system; and
output said control commands to the user to allow the user to verify them.

30. A computer software product for controlling a target system comprising instructions for:
allowing the user to enter a single composite command string;
determining at least one piece of contextual data; and
using said command string and said contextual data to generate one or more control commands for said target system.
